(19) United States
(12) Patent Application Publication
(10) Pub. No.: US 2008/0156957 A1
(43) Pub. Date: Jul. 3, 2008

(54) Method and System for Sign Post Installation

(76) Inventor: Michael Nervi, South Weymouth, MA (US)

Correspondence Address: NATIONAL IP RIGHTS CENTER, LLC;SCOTT J. FIELDS, ESQ., 550 TOWNSHIP LINE ROAD, SUITE 400, BLUE BELL, PA, 19422, US

(21) Appl. No.: 11/617,287

(22) Filed: Dec. 28, 2006

(51) Int. Cl. F16M 13/00

(52) U.S. Cl. 248/530

(57) ABSTRACT

A system for posting signage comprising a cylindrical shaped post, said post having two holes running horizontally there through, the first hole located proximal to the top end of the post and the second hole running proximal to the center of the post, a grooved cone incorporated on the bottom end of the post allowing for screw-type functionality for installing the post into the ground by a twisting motion and a rod that is sized to fit through the first and second hole of the post, said rod being adapted to hold a sign.

### FIELD OF THE INVENTION

The present invention is directed toward an apparatus for hanging signs, and more particularly a convenient method and device for installing a sign post.

### BACKGROUND OF THE INVENTION

Many small commercial signs, such as real estate signs, require frequent relocation. Sign location is often difficult, since it requires the person who must locate the sign to dig a hole, such as with a post-hole digger, then position the sign post and fill the hole. Such a method requires special tools, along with typical skill in using them, as well as significant physical labor. This activity is often inconsistent with the other requirements of the business of the person who needs a sign, e.g. a need to wear business attire. Thus, real estate agents and other business people who use posted signage often hire third parties to install and move signs, and do so at a significant expense. Therefore, a need exists for a sign location method that is convenient enough to be used by a real estate agent or similar person without the need for assistance or tools.

There have been a number of methods and systems directed toward the fixing and posting of signs. These include U.S. Pat. Nos. 5,903,991, 4,910,901, 7,089,694, 4,279,104, 4,326,352, and 4,790,092. None of these devices however discloses a sign post with a screw element for easy installation and the capability to be broken down into two halves for compact storage. Accordingly, the present invention described herein encompasses these elements.

### SUMMARY OF THE INVENTION

It is an object of the present invention to provide a system for posting signage comprising a cylindrical shaped post, said post having two holes running horizontally there through, the first hole located proximal to the top end of the post and the second hole running proximal to the center of the post, a grooved cone incorporated on the bottom end of the post allowing for screw-type functionality for installing the post into the ground by a twisting motion and a rod that is sized to fit through the first and second hole of the post, said rod being adapted to hold a sign.

It is a further object of the present invention to provide a cylindrical shaped post, said post being split into a first top half and a second bottom half, a collar joint mechanism incorporated onto the bottom of the first half of the post and onto the top of the second half of the post, said mechanism having a securing device or system, e.g. a spring button mechanism and a metal plate, affixed to the post in proximity to the top of the grooved cone, which runs horizontally from the post, said plate having a slot for receiving a nail to affix the plate to the ground.

### BRIEF DESCRIPTION OF THE FIGURES

FIG. 1 is a front perspective view of the present invention.

FIG. 2 is a second perspective view of the invention of FIG. 1 showing the preferred method of installation.

FIG. 3 is a perspective view showing an alternative embodiment of the invention.

FIG. 4 is a perspective view of an alternative embodiment of the invention.

FIG. 5 is a perspective view of an alternative embodiment of the invention.

### DESCRIPTION OF THE PREFERRED EMBODIMENT

The invention is described with reference to the enclosed Figures wherein the same numbers are used where applicable.

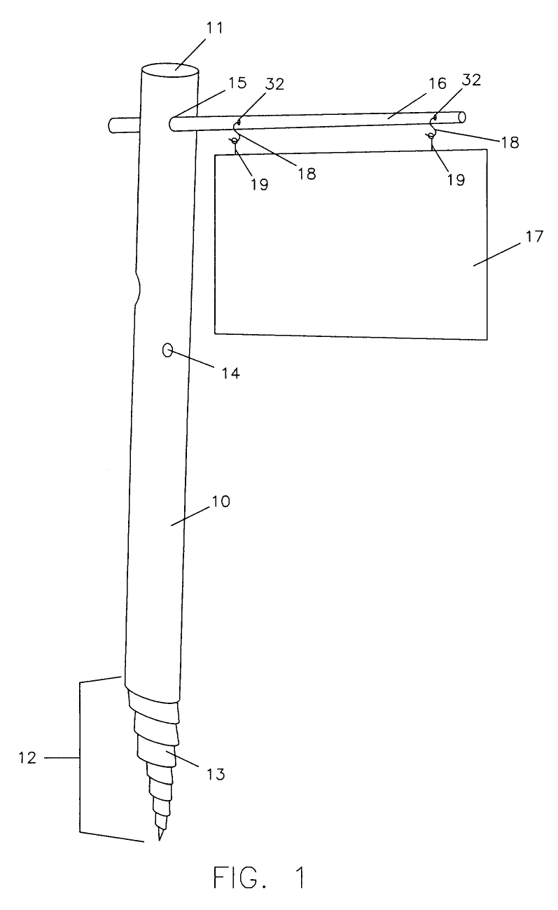

Referring to FIG. 1, the present invention is a cylindrical post 10 comprising a top end 11 and a bottom end 12, wherein the top end 11 has a flat surface and the bottom end 12 forms a grooved screw element 13 for screw-type functionality. The cylindrical post 10 also contains a first hole 15 located in proximity to the top end of the post 10 and a second hole 14 located in proximity to the middle of the post 10. The top hole 15 provides for the ability to insert and hold a rod 16 onto which signage 17 may be affixed.

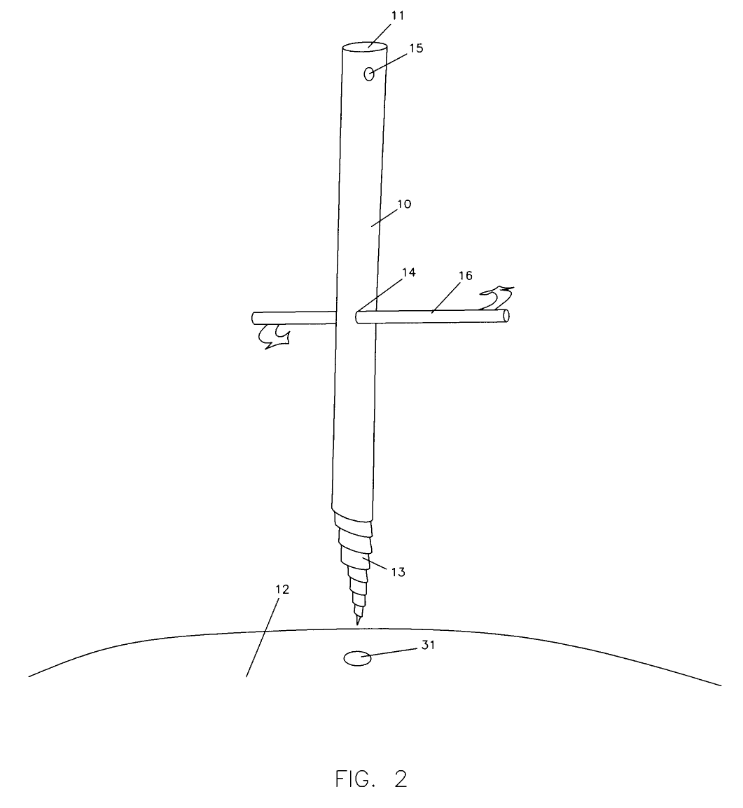

Referring to FIG. 2 of the present invention, the rod 16 is shown inserted through the middle hole 14 of the post 10. The screw element 13 is seen positioned above the ground 12 near a desired placement point 31 where that the post 10 is to be installed. The positioning of the rod 16 through the center hole 14 allows the rod 16 to act as a lever, so that the post 10 may be easily installed into the ground 12 via a twisting motion with minimal physical exertion.

It should be noted that the post 10 can be made of any suitable material such as wood, metal, plastic, fiber, alloy, fiberglass, or polymer. The screw element 13 may be formed as part of a post 10, such as in a molding process or in a carving process, or it can be attached separately such as by a collar joint. Conceivably, in various embodiments, the post 10 and screw element 13 can be made from different materials.

As best seen in FIG. 1 of the preferred embodiment, the signage 17 can be hung using a rod and hook configuration. Hooks 18 are inserted into the hook holes 32 in the rod 16, which is inserted in to hole 15 of post 10. The signage 17 can then be attached to rod 16 via the hooks 18 using latches 19, said latches 19 being attached to the top the signage 17.

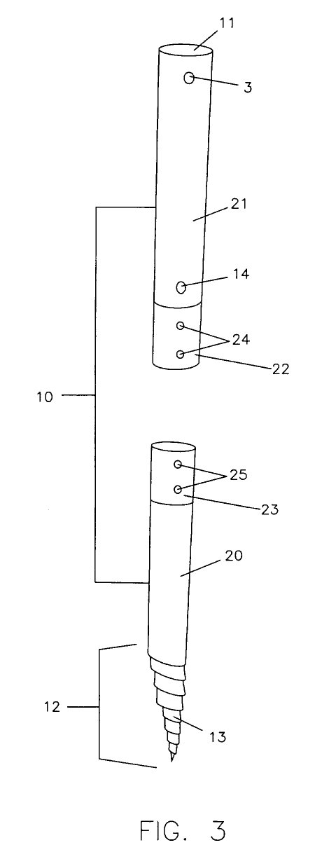

Referring now to FIG. 3, an alternative embodiment of the invention is shown wherein the post 10 is formed from an upper half 21 and a lower half 20. Preferably the hole 14 where the rod 16 is inserted will be located in the upper half 21, as seen in FIG. 3. In other embodiments, the hole 14 can also be located in the lower half 20. The upper half 21 contains a top collar 22 which fits over the bottom collar 23 contained on lower half 20. In the preferred embodiment, the top collar 22 will be fitted with holes 24 which fit over spring loaded buttons 25 that are located on the bottom collar 23. The top collar 22 and bottom collar 23 are attached to the post 10 and can be used in the manner depicted in FIGS. 1 and 2. In other embodiments, various securing mechanisms may also be used, such as with a telescoping post, a screw, or other two-part post mechanisms. Providing a two-part post allows the user to disassemble the post into its two respective halves and store it compactly, e.g. in a car trunk.

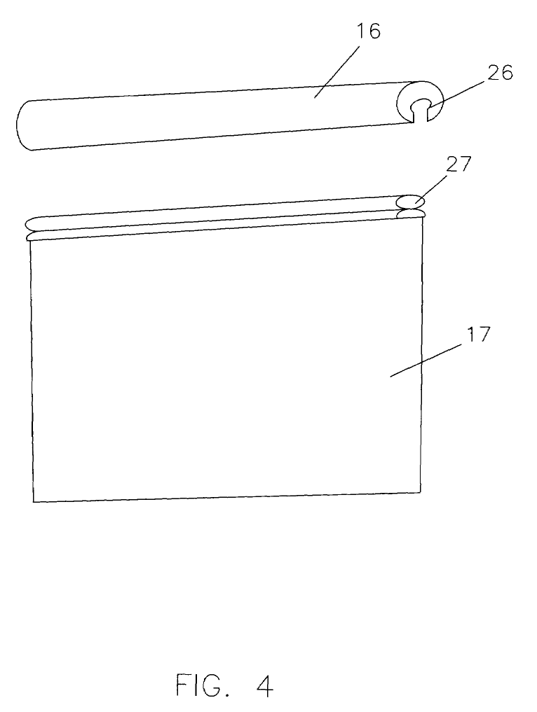

FIG. 4 depicts an alternative embodiment for a piece of signage 17 and rod 16 set, said rod 16 having a receiving groove 26 along its length, through which a top part of a sign comprising a compatible groove 27 may be affixed. In future embodiments, signage may be affixed to the rod by means of hooks, screws, nails, rope or string.

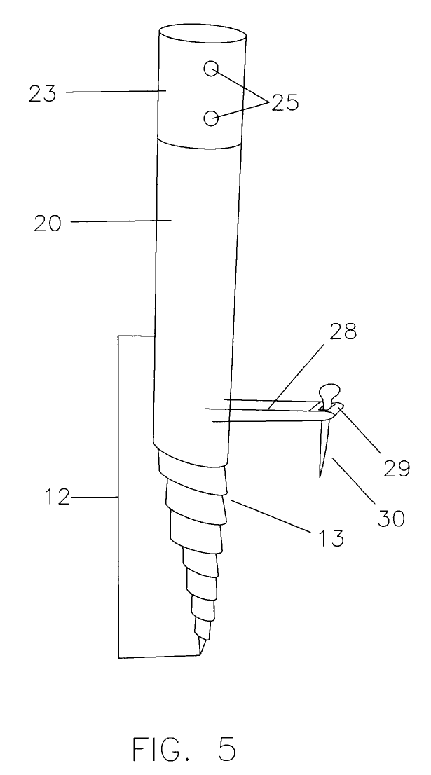

FIG. 5 depicts an alternative embodiment of the invention, wherein a mechanism is included for securing a post 10 after installation. A plate 28 may be connected to the bottom section 20 of the post 10, near the top of the grooved cone 13. The plate 28 will be at ground level once installation has commenced and will extend horizontally from the post 10. Preferably, the plate 28 will include a slot 29 for receiving a nail 30 to provide for further securing of the post 10 into the ground by preventing any further twisting motion by the post 10. Other mechanisms may be used to further secure the post 10, such as ropes or tethers.

The present invention has been described with reference to the above discussed preferred embodiment. The true nature and scope of the invention is determined with reference to the attached claims.

I claim:

1. A system for posting signage comprising:
a cylindrical shaped post,
said post having a top end and bottom end;
said post having a first hole and a second hole running horizontally there through, said first hole located proximal to the top end of the post and said second hole running proximal to the center of the post;
a screw element, incorporated into said bottom end of said post;
a rod, sized to fit through said first hole and said second hole of said post, said rod being adapted to hold a sign.

2. The method of installing the posting signage of claim 1 comprising inserting said rod into said second hole of said post and turning said rod along a circular plane to rotate said screw element so that said post is inserted into the ground.

3. The system for posting signage of claim 1 wherein a securing mechanism is attached to said post further comprising:
a plate attached to said post;
a slot located in said plate; and
a spike capable of being inserted through said slot, said spike being capable of being secured in the ground when said screw element is inserted into the ground.

4. The system for posting signage of claim 1 further comprising a sign to be hung on the rod.

5. The system for posting signage of claim 4 wherein said rod is adapted to hold said sign using a hook and latch configuration.

6. The system for posting signage of claim 4 further, wherein said rod is adapted to hold said sign, said rod further comprising a grooved slot and said sign further comprising a grooved top capable of being inserted into said grooved slot.

7. The system for posting signage of claim 1, wherein said post comprises a top and bottom section, wherein the two sections are adapted to be disconnected and reconnected.

8. The system for posting signage of claim 7, wherein said bottom section further comprises at least one spring loaded button and said top section further comprising at least one hole, said hole being capable of fitting over said spring loaded button in order to secure said top section to said bottom section.
